(19) United States
(12) Patent Application Publication
(10) Pub. No.: US 2009/0267374 A1
(43) Pub. Date: Oct. 29, 2009

(54) RUNNING BOARD WITH STORAGE COMPARTMENT

(75) Inventor: Gary A. Mulder, Clinton Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/109,468

(22) Filed: Apr. 25, 2008

(51) Int. Cl. B60R 3/00

(52) U.S. Cl. 296/37.1; 280/164.1

(57) ABSTRACT

A vehicle includes a vehicle body and a step assembly having a first portion and a second portion. The first portion is mounted with respect to the vehicle body and defines a cavity having an opening. The second portion is mounted with respect to the first portion and is selectively movable between a closed position in which the second portion obstructs the opening and an open position in which the second portion does not obstruct the opening.

### TECHNICAL FIELD

This invention relates to vehicle running boards.

### BACKGROUND OF THE INVENTION

Certain vehicles, especially pickup trucks and sport utility vehicles, have passenger compartments that are situated relatively high off the ground. The prior art includes steps, such as running boards, tubular bars, etc., that provide a surface between the ground and the passenger compartment on which a vehicle user can step to facilitate access to the passenger compartment. Prior art steps do not extend significantly forward or rearward of a vehicle's side doors.

### SUMMARY OF THE INVENTION

A vehicle includes a vehicle body and a step assembly having a first portion and a second portion. The first portion is mounted with respect to the vehicle body and defines a cavity having an opening. The second portion is mounted with respect to the first portion and is selectively movable between a closed position in which the second portion obstructs the opening and an open position in which the second portion does not obstruct the opening. The step assembly facilitates entry into a passenger compartment of the vehicle body, and the cavity provides a storage compartment.

An apparatus for facilitating access to the passenger compartment of a vehicle is also provided. The apparatus includes a step assembly including a first portion and a second portion. The first portion is mountable with respect to the vehicle and defines a cavity having an opening. The second portion is mounted with respect to the first portion and is selectively movable with respect to the first portion between a closed position in which the second portion obstructs the opening, and an open position in which the second portion does not obstruct the opening.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, side view of a pickup truck having a running board with a lid;

FIG. 2 is a schematic, perspective view of the running board of FIG. 1 with the lid in a closed position;

FIG. 3 is a schematic, perspective view of the running board of FIG. 1 with the lid in an open position; and

FIG. 4 is a schematic, cross-sectional view of the running board of FIG. 1.

### DESCRIPTION OF THE PREFERRED EMBODIMENTS

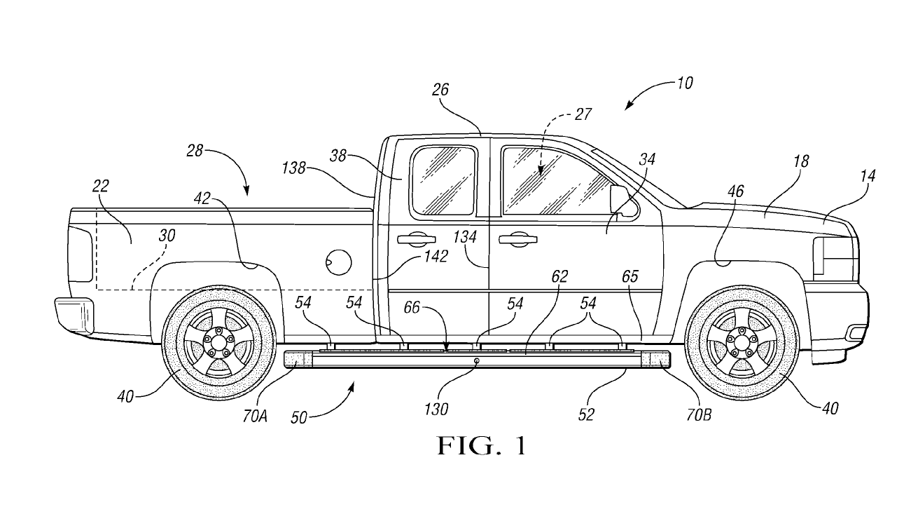

Referring to FIG. 1, a vehicle 10 includes a vehicle body 14. The vehicle body 14 in the embodiment depicted is characterized by a pickup truck configuration, although other vehicle body configurations may be employed within the scope of the claimed invention. For example, vehicle body 14 may be a minivan, a sport-utility vehicle, etc. The vehicle body 14 includes various body panels, including fenders 18 and rear quarter panels 22.

The body 14 includes a cab portion 26 that defines a passenger compartment 27, and a cargo box 28 that is situated rearward of the cab portion 26. The cargo box 28 is defined by the quarter panels 22, which form the sidewalls of the cargo box, a cargo bed floor 30, the rearward end of the cab portion 26, and a tailgate (not shown), as understood by those skilled in the art. The vehicle body 14 includes front doors 34 and rear doors 38 that provide selective access to the passenger compartment in the cab portion 26. Although front and rear doors 34, 38 are shown in the embodiment depicted, a vehicle body 14 may include any quantity of doors within the scope of the claimed invention.

The vehicle 10 includes wheels 40 rotatably mounted with respect to the vehicle body 14, as understood by those skilled in the art. Each rear quarter panel 22 defines a respective wheel well 42 in which one of the wheels 40 is partially located. Each fender 18 defines a respective wheel well 46 in which one of the wheels 40 is partially located.

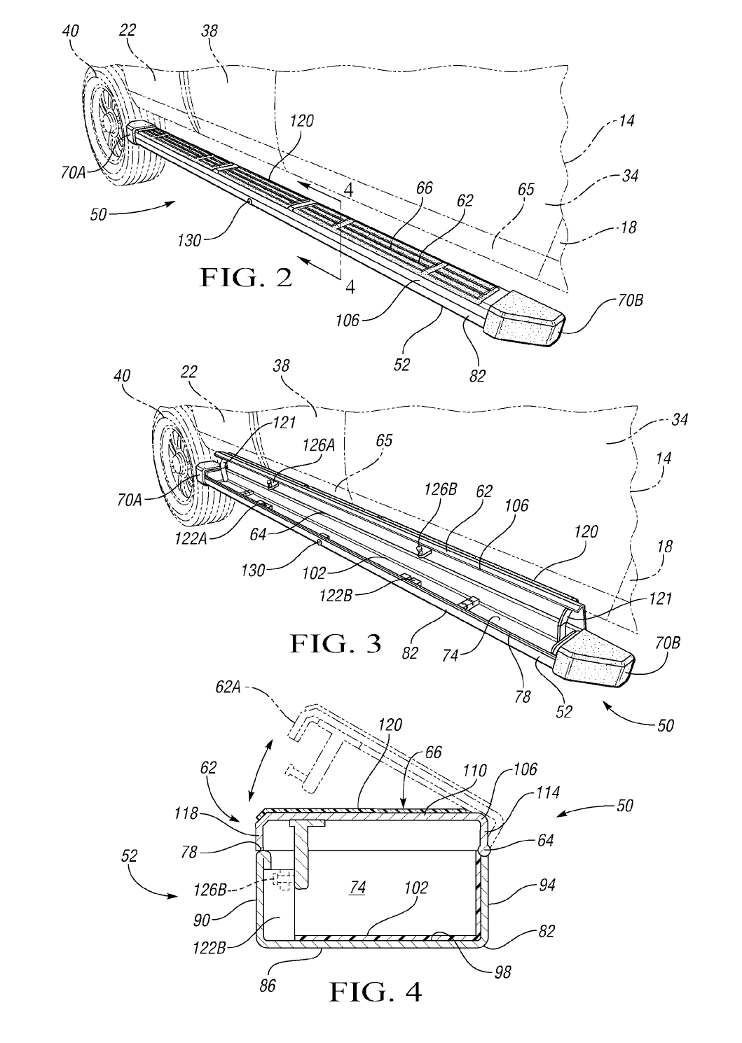

The vehicle 10 also includes a step assembly 50. The step assembly 50 includes a first portion 52 mounted with respect to the vehicle body 14 via brackets 54. In an exemplary embodiment, the brackets 54 mount the first portion 52 to the frame (not shown) of the vehicle 10. The step assembly 50 also includes a second portion 62 that is rotatably mounted to the first portion 52 via a hinge (shown at 64 in FIGS. 3 and 4) adjacent the vehicle body's rocker panel 65. The second portion 62 defines a surface 66 that is generally horizontally oriented when the second portion 62 is in the position shown in FIGS. 1 and 2, and functions as a step surface on which a vehicle user can step to enter the passenger compartment. When the second portion 62 of the step assembly 50 is in the position shown in FIGS. 1 and 2, surface 66 is lower than, and outboard of, the doors 34, 38, the passenger compartment 27, and the rocker panel 65. Accordingly, the step assembly 50 functions as a running board. A composite rear end cap 70A is mounted to the rearward end of the first portion 52, and a composite front end cap 70B is mounted to the forward end of the first portion 52.

Referring to FIG. 4, the first portion 52 of the step assembly 50 defines a cavity 74 having an opening 78. In the embodiment depicted, the first portion 52 of the step assembly 50 includes a generally C-shaped metal member 82 having a generally horizontal wall 86 and two generally vertical walls 90, 94. Each of the vertical walls 90, 94 extends upwardly from a respective end of the generally horizontal wall 86. The walls 86, 90, 94 cooperate to define a cavity 98. A plastic liner 102 is mounted to the member 82 inside the cavity 98. The plastic liner 102 defines cavity 74. Thus, the cavity 74 defined by the liner 102 is substantially coextensive with the cavity 98 defined by the metal member 82. The cavity 74 functions as a storage compartment.

The second portion 62 of the step assembly 50 includes a generally C-shaped metal member 106 having three walls 110, 114, 118. Walls 114, 118 extend from respective ends of wall 110. Wall 114 of member 106 is rotatably mounted to wall 94 of member 82 via hinge 64. In the embodiment depicted, the second portion 62 also includes a plastic or elastomeric step pad or scuff plate 120 that is mounted to wall 110 and that defines surface 66. It should be noted that the first and second portions 52, 62 may have other shapes and configurations within the scope of the claimed invention. For example, the cross-sectional shapes of the first and second portions 52, 62 may be such that the step assembly 50 has an oval cross-sectional shape; the second portion may be board-shaped instead of C-shaped; the first portion may be connected to the body 14 such that walls 94, 114 define the upper surface of the step assembly 50; etc.

The second portion 62, including member 106, is selectively movable with respect to the first portion 52 between a closed position, as shown in FIGS. 1, 2, and 4, and an open position, as shown in FIG. 3 and in phantom at 62A in FIG. 4. More specifically, and in the embodiment depicted, the second portion 62 is selectively rotatable about hinge 64 between the open and closed positions. Alternatively, and within the scope of the claimed invention, the second portion 62 may be selectively translatable, e.g., along a track, with respect to the first portion 52 between an open and a closed position.

When the second portion 62 is in the closed position, the member 106 obstructs the opening 78 of the cavity 74. More specifically, when the second portion 62 is in the closed position, wall 110 extends over and across the cavity 74 and wall 118 of the member 106 abuts wall 90 of member 82, thereby closing the opening 78 and protecting any contents stored in the cavity 74. Flanges and seals (not shown) may be employed within the scope of the claimed invention to prevent dust, water, etc. from entering the cavity 74 when the second portion 62 is in the closed position. When the second portion 62 is in the closed position, wall 110 is generally horizontally oriented and surface 66 faces upward.

When the second portion of the step assembly 50 is in the open position, as shown at 62A in FIG. 4, wall 118 is separated from wall 90, thereby providing access to the cavity 74 via opening 78. Accordingly, the second portion 62 of the step assembly 50 functions as a closure or lid. Referring specifically to FIG. 3, the step assembly 50 includes two hold-open struts 121. Each strut 121 operatively interconnects the second portion 62 and the first portion 52 at a respective end of the cavity 74. The struts 121 spring bias the second portion 62 in the open position.

Referring to FIGS. 3 and 4, the step assembly 50 includes a first latch 122A and a second latch 122B. Latches 122A, 122B are mounted to member 82 of the second portion 62 and are spaced a distance apart from one another. The step assembly also includes a first striker 126A and a second striker 126B. The strikers 126A, 126B are mounted to member 106 of the second portion 62 of the step assembly 50. Each striker 126A, 126B is positioned to engage a respective one of the latches 122A, 122B when the second portion 62 of the step assembly 50 is in the closed position, as depicted in FIG. 4. Thus, latches 122A, 122B and strikers 126A, 126B are operative to releasably maintain the second portion 62 of the step assembly 50 in the closed position.

The step assembly 50 further includes a latch release device 130 that is operatively connected to both of the latches 122A, 122B. The latch release device 130 is selectively manipulable by a vehicle user to disengage the latches 122A, 122B and thereby release the strikers 126A, 126B from the latches 122A, 122B. Thus, a vehicle user can disengage both latches 122A, 122B using a single motion and a single latch release device 130. When the strikers 126A, 126B are released from the latches 122A, 122B, the struts 121 urge the second portion 62 from the closed position to the open position. A connection system (not shown) operatively interconnects the latch release device 130 with both latches 122A, 122B. In an exemplary embodiment, the connection system is mechanical, and employs cables or rods. In another exemplary embodiment, the connection system is electrical, and includes actuators (not shown) to cause the disengagement of the latches 122A, 122B. In the embodiment depicted, the latch release mechanism is a key cylinder, which is selectively rotatable with a corresponding key (not shown) to release the latches 122A, 122B.

Referring to FIGS. 1 and 3, the cavity 74 and the opening 78 extend forward of the rearward edge 134 of door 34, and rearward of the forward extent 138 of the cargo box 28 and the forward extent 142 of the quarter panel 22. In the embodiment depicted, the length of the cavity 74 and the opening 78 is eighty-two inches, which is greater than the length of the cargo box 28 and greater than the length of the cab portion 26. Accordingly, the step assembly 50 can store items that cannot fit entirely within either the cargo box 28 or the cab portion 26. In the embodiment depicted, the second portion 62 extends substantially the entire length of the cavity 74 so that the cavity 74 is fully accessible when the second portion 62 is in the open position. The step assembly 50 is positioned outboard of, and lower than, the doors 34, 38, the rocker panel 65, and the quarter panel 22.

While the best modes for carrying out the invention have been described in detail, those familiar with the art to which this invention relates will recognize various alternative designs and embodiments for practicing the invention within the scope of the appended claims.

1. A vehicle comprising:
a vehicle body;
a step assembly including a first portion and a second portion;
said first portion being mounted with respect to the vehicle body and defining a cavity having an opening;
said second portion being mounted with respect to the first portion and being selectively movable between a closed position in which the second portion obstructs the opening and an open position in which the second portion does not obstruct the opening.

2. The vehicle of claim 1, wherein said second portion is selectively rotatable with respect to the first portion between the open and closed positions.

3. The vehicle of claim 2, further comprising at least one latch mounted with respect to one of the first and second portions; and
at least one striker mounted with respect to the other of the first and second portions and being releasably engageable with said at least one latch;
wherein said at least one striker is sufficiently positioned to engage said at least one latch when the second portion is in the closed position.

4. The vehicle of claim 3, wherein said at least one latch includes a first latch and a second latch; wherein said at least one striker includes a first striker and a second striker; and wherein the step assembly further includes a latch release device that is operatively connected to the first and second latches and that is operative to disengage the first and second strikers from the first and second latches.

5. The vehicle of claim 4, wherein the latch release mechanism is a key cylinder.

6. The vehicle of claim 2, wherein the second portion defines the upper surface of the step assembly when the second portion is in the closed position.

7. The vehicle of claim 1, wherein the vehicle body includes a side door; and wherein the step assembly is outboard of, and below, the side door.

8. The vehicle of claim 7, wherein the vehicle body includes a quarter panel characterized by a forwardmost extent, and wherein the cavity extends rearward of the forwardmost extent.

9. The vehicle of claim 1, wherein the vehicle body is characterized by a pickup truck configuration and defines a cargo box; and wherein the length of the cavity exceeds the length of the cargo box.

10. An apparatus for facilitating access to the passenger compartment of a vehicle comprising:
a step assembly including a first portion and a second portion;
said first portion being mountable with respect to the vehicle and defining a cavity having an opening; and
said second portion being mounted with respect to the first portion and being selectively movable between a closed position in which the second portion obstructs the opening and an open position in which the second portion does not obstruct the opening.

11. The apparatus of claim 10, further comprising a plurality of brackets being mounted to the first portion and sufficiently configured to operatively connect the first portion to the vehicle.

12. The apparatus of claim 10, wherein said second portion is selectively rotatable with respect to the first portion between the open and closed positions.

13. The apparatus of claim 12, further comprising at least one latch mounted with respect to one of the first and second portions; and
at least one striker mounted with respect to the other of the first and second portions and being releasably engageable with said at least one latch;
wherein said at least one striker is sufficiently positioned to engage said at least one latch when the second portion is in the closed position.

14. The apparatus of claim 13, wherein said at least one latch includes a first latch and a second latch; wherein said at least one striker includes a first striker and a second striker; and wherein the step assembly further includes a latch release mechanism that is operatively connected to the first and second latches and that is operative to disengage the first and second strikers from the first and second latches.

15. The apparatus of claim 14, wherein the latch release mechanism is a key cylinder.
